(19) United States
(12) Patent Application Publication
(10) Pub. No.: US 2011/0079075 A1
(43) Pub. Date: Apr. 7, 2011

(54) MOLECULAR IMPRINTED THREE-DIMENSIONALLY ORDERED MACROPOROUS SENSOR AND METHOD OF FORMING THE SAME

(75) Inventors: Zhi Zheng, Shanghai (CN); Linan Zhao, Shanghai (CN); Marilyn Wang, Shanghai (CN)

(73) Assignee: Honeywell International Inc.

(21) Appl. No.: 12/572,427

(22) Filed: Oct. 2, 2009

(51) Int. Cl. G01N 15/08

(52) U.S. Cl. 73/38

(57) ABSTRACT

A molecular imprinted three-dimensionally ordered macroporous (MiTOM) sensor for detecting small organic molecules and a method of forming the same. A target template associated with a number of pores can be formed by vertical deposition of organic polymer particles on a substrate. Active monomers can be added to a solution during an infiltration process of the target template. The monomers associated with ligands can be polymerized around the target template so that the ligands can be stereochemically fixed at precise binding sites associated with the target template. The target template can then be removed in order to form a MiTOM sensor electrode, which includes an inverse opal structure. Additionally, an inverse opal backbone structure can be formed and coated with the layer of target template and active monomers in order to form molecular imprinted active sites on the inverse opal backbone structure after a self-assembly and polymerization process.

### TECHNICAL FIELD

Embodiments are generally related to sensors. Embodiments are also related to macroporous materials. Embodiments are additionally related to the formation of molecularly imprinted three-dimensionally ordered macroporous (MiTOM) sensors.

### BACKGROUND OF THE INVENTION

The development of “smart” sensors capable of detecting organic molecules has become increasingly important in the detection of pesticides in, for example, farm products, glucose concentration in diabetes diagnostics, sarin in antiterrorism efforts, cholesterol in nutrient recipe, and so forth. Most current detection and analysis of organic molecules takes place in a biochemical lab with often large and cumbersome equipment. Such an approach is expensive and slow and requires a professional to operate such equipment.

Chemical sensors, especially biosensors operating with bioactive components, may be based on microporous and mesoporous materials such as, for example, SnO₂ or WO₃ films. Such microporous and mesoporous materials typically possess a very high specific area; however, because the pores are irregular and less than 50 nm (or even less than 20 nm), the fluent resistance of the sensing material is higher. Additionally, such materials are relatively difficult to clean after each usage and the residue of a previous sample can affect a new measurement.

In some prior art chemical sensors, a molecular imprinting process (also referred to as “templating”), may be employed for sensing small organic molecules with an outstanding specificity. Molecular imprinting is a process of preparing materials that are selective for a particular compound (i.e., the imprint molecule) or a set of related compounds. Prior art imprinting techniques, however, suffer from leakage of the template molecule after formation of the imprint, which hinders the application of conventional molecular imprints. The leakage of template refers to the phenomenon that many template molecules can be trapped deep within the imprint matrix. The trapped template molecules that are not removed may leak during utilization of the molecular imprint. If such materials are employed for sensing, the template left may cause a high baseline and a low signal-to-noise ratio, so that the resulting sensitivity is low. A vesicant may be added to the materials to create pores within the polymer and thus enhance the removal of the template. The leakage of template, however, still remains in such situations.

Based on the foregoing, it is believed that a need exists for an improved molecular imprinted three-dimensionally ordered macroporous (MiTOM) sensor and a method of forming and using the same. A need also exists for an improved method for configuring a MiTOM sensor, as described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved chemical sensor and a method of forming and using the same.

It is another aspect of the disclosed embodiments to provide for an improved molecular imprinted three-dimensionally ordered macroporous (MiTOM) sensor having a high specificity and fast response time.

It is a further aspect of the disclosed embodiments to provide for an improved method of forming a MiTOM sensor.

The aforementioned aspects and other objectives and advantages can now be achieved as described herein. A molecular imprinted three-dimensionally ordered macroporous (MiTOM) sensor for detecting small organic molecules and a method of forming the same are disclosed. A target template (e.g., a direct opal film) associated with a number of pores may be formed by vertical deposition of organic polymer particles (e.g., polystyrene spheres) on a substrate (e.g., glass). Active monomers (e.g., titanium isopropoxide) can be added to a solution during an infiltration of the target template. The monomers associated with ligands can be polymerized about the target template so that the ligands are then stereochemically fixed at exact binding sites associated with the target template. A target template can then be removed in order to form a MiTOM sensor electrode having an inverse opal structure. Additionally, an inverse opal backbone structure may be configured and coated with a layer of the target template and an active monomer in order to form molecular imprinted active sites on an inverse opal backbone structure after implementation of a self-assembly and polymerization process.

The target template interacts with the complementary portion of the monomer, either covalently or by interactions such as ionic, hydrophobic, or hydrogen bonding. The target template may be removed to leave a recognition site that serves to interact with the target template molecule or some analogous molecule with similar physical/chemical characteristics. The MiTOM sensor electrode can be employed as a sensing material in association with an electrochemical sensor, a SAW sensor, a QCM sensor, an F-bar, and/or a piezoelectric sensor. The pores of the macroporous sensor (which includes an inverse opal structure) can be closely packed in a face-centered cubic structure. The inverse opal backbone structure increases the specific surface area of the sensor apparatus, which enhances the sensitivity and response speed greatly. The size of the interconnecting and large pores of the MiTOM sensor possesses less resistance to the flow of fluent. Also, the fluent flows fast and freely in the macroporous sensor apparatus and as a result, the detection speed is high and the sensor can be easily refreshed by flushing with air/solvent after a detection operation.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a vertical deposition structure that includes polystyrene spheres, in accordance with the disclosed embodiments;

FIG. 2 illustrates an exploded view of a target template, in accordance with the disclosed embodiments;

FIG. 3 illustrates an exemplary view of a MiTOM electrode with an inverse opal structure, in accordance with the disclosed embodiments;

FIG. 4 illustrates a schematic view of a molecular imprinting process, in accordance with the disclosed embodiments;

FIG. 5 illustrates an exploded view of MiTOM electrode associated with binding sites, in accordance with the disclosed embodiments;

FIG. 6 illustrates an electrochemical sensing process associated with the MiTOM electrode, in accordance with an embodiment;

FIG. 7 illustrates a high level flow chart of operations illustrating logical operational steps of a method for forming an MiTOM sensor apparatus, in accordance with the disclosed embodiments; and

FIG. 8 illustrates a high level flow chart of operations illustrating logical operational steps of a method for forming the MiTOM sensor apparatus, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The disclosed embodiments may be employed to form a macroporous structure and, preferably, a molecular imprinted three-dimensionally ordered macroporous (MiTOM) structure, of many compositions. The approach described herein utilizes the technique of molecular imprinting, which provides significant advantages over currently available molecular imprinting technologies. Molecules may be detected, captured, isolated, analyzed, and/or quantified according to the disclosed embodiments and utilizing a molecular imprinting process.

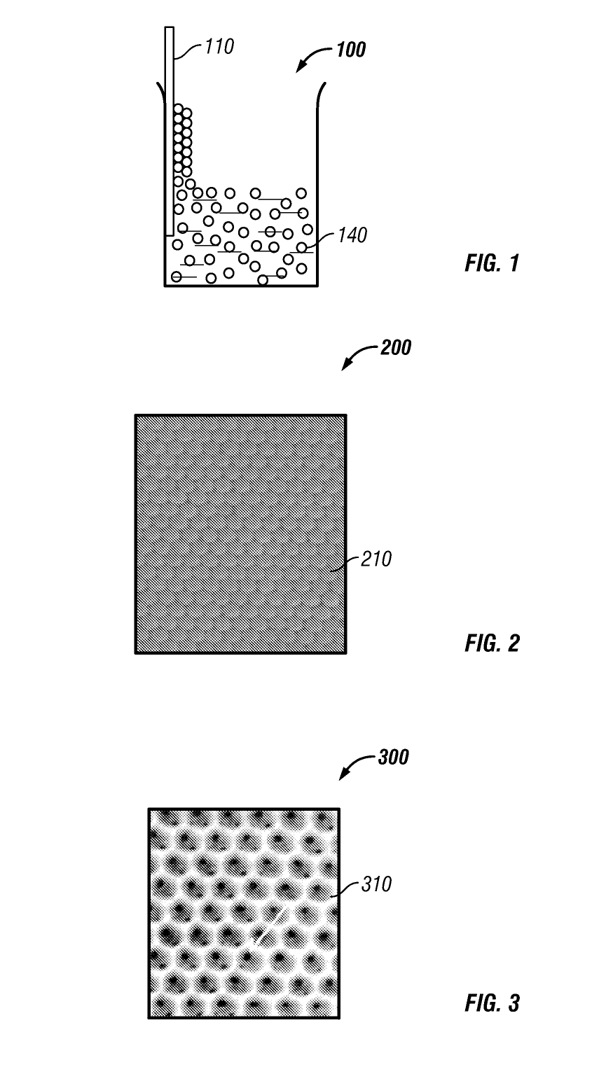

FIG. 1 illustrates a side view of a vertical deposition structure 100 that includes polystyrene spheres 140, in accordance with the disclosed embodiments. FIG. 2 illustrates a side view of a target template 200 (e.g., a direct opal film) that includes a number of pores 210 in accordance with the disclosed embodiments and which may be formed by vertical deposition of organic polymer particles 140 on a substrate 110 (e.g., glass). Note that in FIGS. 1-2, identical or similar parts or elements are generally indicated by identical reference numerals. The organic polymer particles 140 described herein may be, for example, materials such as polystyrene spheres or other appropriate materials, depending upon design considerations. It can be appreciated that other shapes may be utilized in place of the suggested shape. The thickness of the target template 200 can be controlled by the concentration of the organic polymer particles 140. The concentration of the organic polymer particles 140 permits precise control over the phase and thicknesses of the walls of the target template 200, as well as favoring the formation of an efficient interconnectivity between the pores 210 of the organic polymer particles 140.

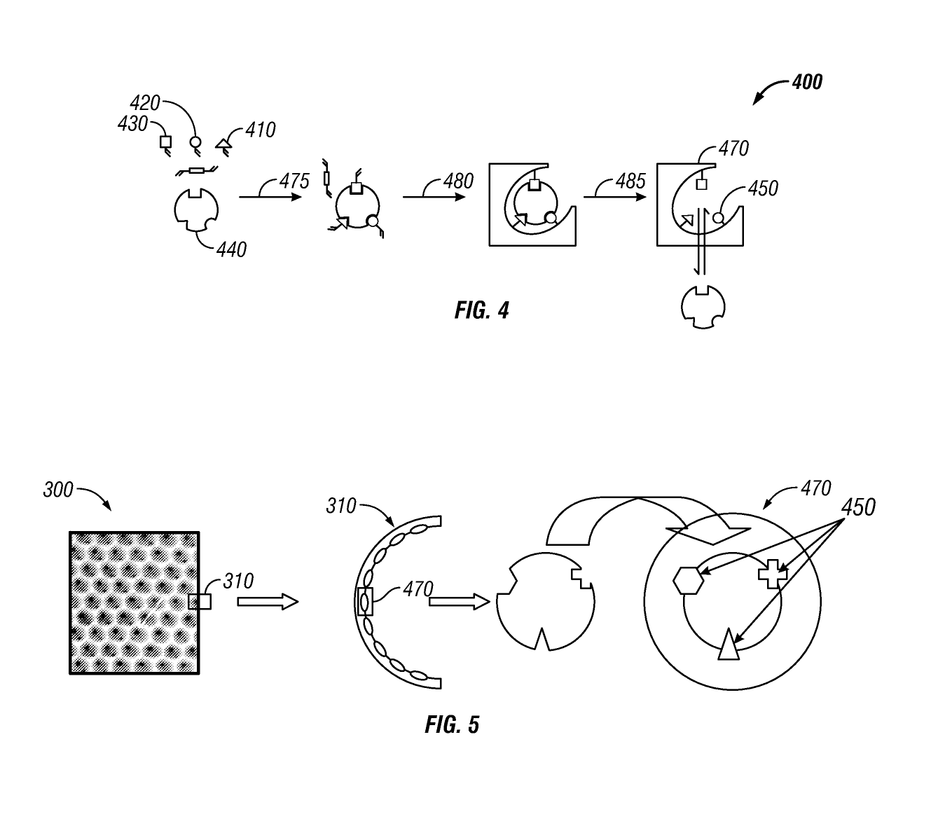

A mixture of monomer (e.g., Titanium isopropoxide) and Chitosan may be added to a solution during an infiltration process of the target template 200. The mixture is generally added to the target template 200 by soaking the target template 200 in the composition. The monomers 410, 420, and 430 associated with ligands can be polymerized around the target template 200 so that the ligands can be stereochemically fixed at exact binding sites 450 associated with the target template 200, as shown in FIG. 4. The target template 200 can then be removed in order to form the MiTOM electrode 300 with an inverse opal structure 310.

FIG. 3 illustrates an exemplary view of the molecular imprinted three-dimensionally ordered macroporous (MiTOM) electrode 300 with an inverse opal structure 310, in accordance with the disclosed embodiments. Note that in FIGS. 1-8, identical or similar elements and parts are generally indicated by identical referenced numerals. The pores 210 of the MiTOM electrode 300 can be closely packed in a face-centered cubic (fcc) structure. The pores 210 associated with the MiTOM electrode 300 increase the surface area and produce additional surface sites, which enhance the sensitivity and response speed greatly of the resulting sensor. The MiTOM electrode 300 includes an inverse opal structure 310, which can provide high performance by maintaining high capacities as discharge rates are increased. In addition to the material properties of the MiTOM electrode 300, attributes such as particle size and morphology may also be optimized via the disclosed embodiments. The inverse opal structure 310 also minimizes the diffusion pathway lengths and provides improved electrode properties in resulting sensor applications.

FIG. 4 illustrates a schematic view of a molecular imprinting process 400, in accordance with an embodiment. The target template molecule 440 in association with the active monomers 410, 420, and 430 form molecular imprinted active sites 470 after completion of respectively self-assembly and polymerization processes 475 and 480. The target molecule 440 may be, for example, organic polymer particles 140 such as those depicted in FIG. 1. For macromolecular targets, the template molecule 440 may possess a structure that corresponds to a portion of a consensus sequence derived from a family of macromolecules. Any substrate, including a biologically active compound, and particularly a macromolecule, that exhibits a desired property, may be selected as a template to be imitated synthetically. Note that a “macromolecule” may be considered as molecules having a molecular weight in the range of two or three thousand to many million.

Biological macromolecules are important regulators of physiological functions. The size and tertiary structure of the active macromolecule convey significant chemical information through highly specific interactions with receptors, enzymes, nucleic acids, or other biological mediators interacting with the macromolecule. Note that events such as diverse as thrombosis, inflammation, and immunologic responses may be controlled, at least in part, by the three dimensional topology of the disclosed macromolecules. The surface of the macromolecule is generally composed of geometrically distributed groups, which impart ionic, hydrophobic, steric, electrostatic, and hydrogen bonding characteristics to the molecule and additionally provide a molecular template for receptor binding.

Molecular imprinting is a promising technique for the preparation of polymers with predetermined selectivity and high affinity. Normally, the imprinted polymers 470 may be produced by cross-linking polymerizations based on the self-assembly 475 of the functional monomers 410, 420, and 430 and the template molecules 440 (i.e., imprint molecules). The template molecules 440 can be subsequently removed from the polymer by solvent extraction 485, leaving behind the binding sites 450 complementary to the imprint species in terms of the shape and the position of functional groups. Recognition of the polymer constitutes an induced molecular memory, which renders the binding sites 450 capable of selectively recognizing the imprint species.

FIG. 5 illustrates an exploded view of MiTOM electrode 300 with an inverse opal structure 310 associated with binding sites 450, in accordance with the disclosed embodiments. The mixture of target template molecules 440 and the active monomers 410, 420, and 430 may be added to a solution during the infiltration process of the target template 200. The monomers 410, 420, and 430 associated with ligands can be polymerized around the target template molecules 440 so that the ligands can be stereochemically fixed at exact positions where the binding sites 450 of the template molecule 440 exist. The target template molecules 440 can then be removed in order to form the molecular imprinted three-dimensionally ordered macroporous electrode 300 with the inverse opal structure 310.

The target molecule 440 can interact with a complementary portion of the functional monomers 410, 420, and 430, either covalently or by other interactions such as ionic, hydrophobic or hydrogen bonding. The target template molecule 440 can be removed from the cross-linked polymer 470 when polymerization is complete. The removal of the target template molecule 440 leaves a bead having a macroporous structure with complementary molecular cavities that posses a specific binding affinity for the target molecule 440. In embodiments wherein the template molecule 440 is covalently bound to the functional monomers 410, 420, and 430, any appropriate method can be employed to cleave the covalent bond, although the covalent bond formed can preferably be cleaved under conditions suitable to release the imprint molecule after the polymer 470 is formed, without adversely affecting the selective binding characteristics of the polymer 470.

The target molecule 440 can be removed to leave the recognition site that serves to interact with the target molecule or some analogous molecule with similar physical/chemical characteristics. The MiTOM electrode 300 can then be utilized in a sensor with separation or catalytic operations wherein the target molecule 440 is targeted. Such a technique may be “host-guest polymerization” or “template polymerization”. The MiTOM electrode 300 can be utilized as a sensing material in a wide range of sensor applications including, but not limited to, an electrochemical sensor, a SAW sensor, a QCM sensor, and an F-bar or piezoelectric sensor. The MiTOM electrode 300 in association with such sensors can provide a high sensitivity and a fast response time during sensing operations.

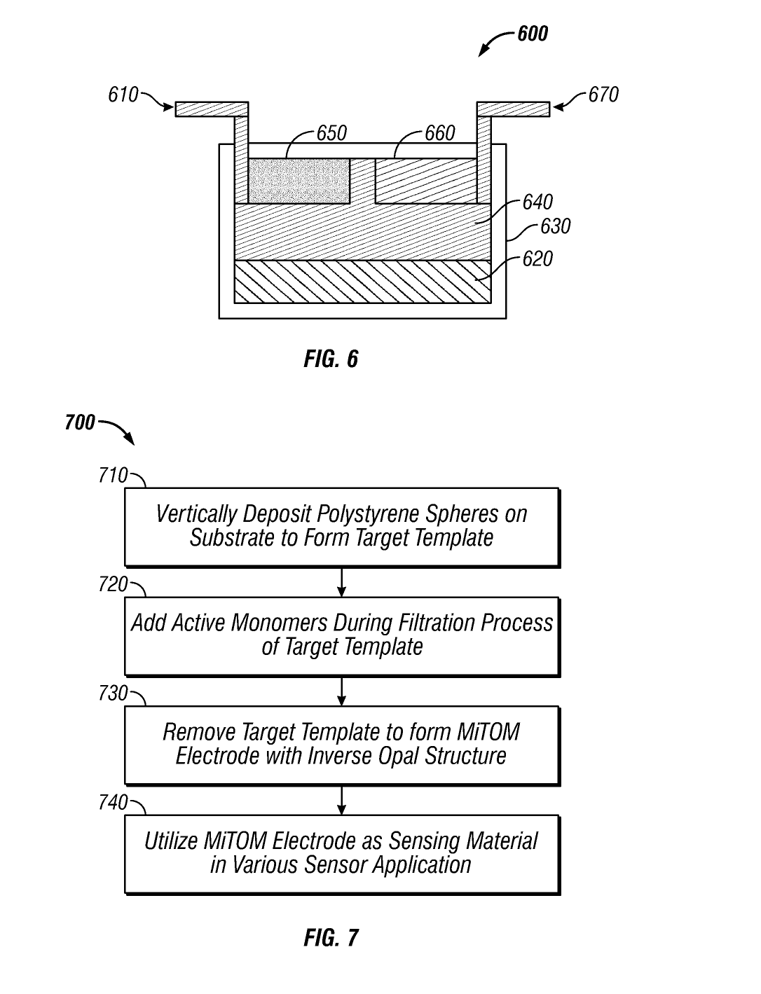

FIG. 6 illustrates an electrochemical sensing process 600, in accordance with an embodiment. The MiTOM electrode 300 described herein can generate a signal utilizing different methods including, for example, but not limited to, electrochemical, surface acoustic wave, quartz crystal microbalance, piezoelectric, F-bar, and SERS, etc. The electrochemical sensing process 600 generally includes a sensing electrode (or working electrode) 620 and a counter electrode 650 separated by a thin layer of liquid or gas 640 within a shell 630. The MiTOM electrode 300 can be utilized as the sensing electrode 620. Liquid or gas that comes in contact with the sensor (that employs the electrode) first passes through a small inlet 610 and eventually reaches the electrode surface 620 and moves through the outlet 670. Such an approach can be adopted to permit the proper amount of gas to react at the sensing electrode 620 to produce a sufficient electrical signal while preventing the electrolyte 640 from leaking out of the sensor 300.

A reference electrode 660 may be placed within the electrolyte 640 in close proximity to the sensing electrode 620 to improve the performance of the sensor. The reference electrode 660 maintains the value of fixed voltage at the sensing electrode 620. No current flows to or from the reference electrode 660. The gas molecules react at the sensing electrode 620 and the current flow between the sensing and the counter electrode 620 and 650 can be measured and is typically related directly to the gas concentration. The value of the voltage applied to the sensing electrode 620 makes the sensor specific to the target gas.

FIG. 7 illustrates a high level flow chart of operations illustrating logical operational steps of a method 700 of configuring a molecular imprinted three-dimensionally-ordered macroporous sensor, in accordance with the disclosed embodiments. The polystyrene spheres 140 can be vertically deposited on the substrate 110 in order to form the template 200 with a number of pores 210, as depicted at block 710. Thereafter, active monomers 410, 420, and 430 can be added to the solution during infiltration process of the target template 200, as illustrated at block 720. The polystyrene spheres 140 can be removed in order to form the MiTOM electrode 300 with inverse opal structure 310, as indicated at block 730. The molecular imprinted three-dimensionally-ordered macroporous electrode 300 can be utilized as sensing material in various sensor applications, as depicted at block 740.

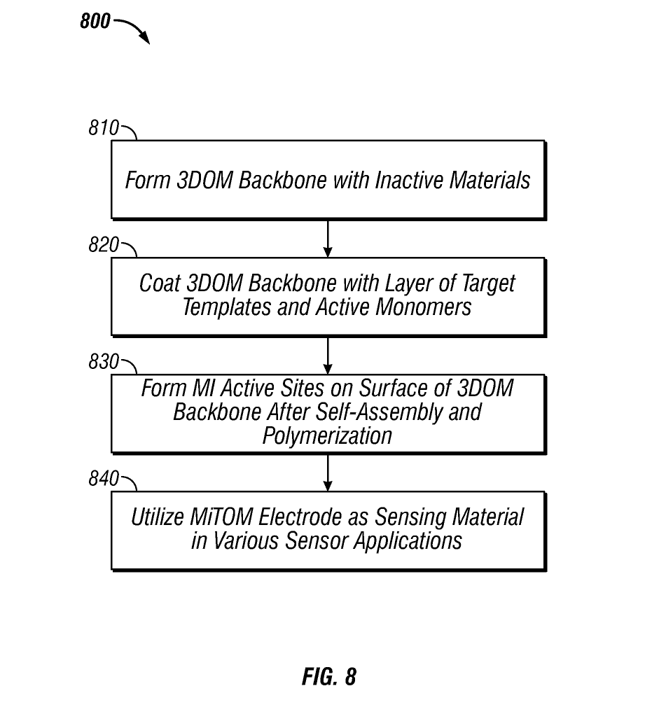

FIG. 8 illustrates a high level flow chart of operations illustrating logical operational steps of a method 800 for forming a molecular imprinted three-dimensionally-ordered macroporous sensor, in accordance with the disclosed embodiments. A 3DOM backbone can be formed with inactive materials, as depicted at block 810. The template molecules 440 and active monomers 410, 420, 430 can be added to the 3DOM backbone, as depicted at block 820. The MI active sites can be formed on the surface of 3DOM backbone after self-assembly and polymerization process 475 and 480, as indicated at block 830. The molecular imprinted three-dimensionally-ordered macroporous electrode 300 can be utilized as sensing material in various sensor applications, as depicted at block 840.

The macroporous structures formed by the disclosed embodiments of the present invention can be made in a large range of sizes. The size of the interconnecting and large pores of the MiTOM electrode 300 possesses less resistance to the flow of fluent. Also, since the fluent flows fast and freely in the MiTOM sensor apparatus, as a result the detecting speed is high and the sensor apparatus can be easily refreshed by flush with air/solvent after the detection. The MiTOM electrode 300 described herein can provide high sensitivity because of the high specific area.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A macroporous sensor, said sensor comprising:
a target template having a plurality of pores formed by vertical deposition of a plurality of organic polymer particles on a substrate;
an active monomer added to a solution during an infiltration operation with respect to said target template, wherein said active monomer is associated with a plurality of ligands and is polymerized about said target template; and
a macroporous electrode, wherein said target template is removable to form said macroporous electrode for use in sensing operations by said macroporous sensor.

2. The sensor of claim 1 wherein said plurality of ligands is stereochemically fixed at precise binding sites associated with said target template.

3. The sensor of claim 1 further comprising:
an inverse opal macroporous backbone structure; and
a layer of said target template and said active monomer that form a plurality of molecular imprinted active sites on said inverse opal backbone structure after a self-assembly and polymerization process step.

4. The sensor of claim 1 wherein said active monomer comprises an organic polymer precursor.

5. The sensor of claim 1 wherein said plurality of organic polymer particles comprises a plurality of polystyrene spheres.

6. The sensor of claim 1 wherein said macroporous electrode comprises an ordered, three-dimensional structure.

7. The sensor of claim 1 wherein said substrate comprises glass.

8. A molecular imprinted three-dimensionally ordered macroporous sensor, said sensor comprising:
a substrate;
a target template that includes a plurality of pores configured by deposition of a plurality of organic polymer particles on said substrate;
an active monomer added to a solution during an infiltration operation with respect to said target template, wherein said active monomer is associated with a plurality of ligands and is polymerized proximate to said target template; and
a molecularly imprinted macroporous electrode, wherein said target template is removable to form said molecularly imprinted macroporous electrode, said molecularly imprinted macroporous electrode having an ordered, three-dimensional structure and utilized by said molecular imprinted three-dimensionally ordered macroporous sensor for use in sensing operations.

9. The sensor of claim 8 wherein deposition of said plurality of organic polymer particles on said substrate comprises a vertical deposition.

10. The sensor of claim 8 wherein said plurality of ligands is stereochemically fixed at exact binding sites associated with said target template.

11. The sensor of claim 8 further comprising:
an inverse opal macroporous backbone structure; and
a layer of said target template and said active monomer that form a plurality of molecular imprinted active sites on said inverse opal backbone structure after a self-assembly and polymerization process step.

12. The sensor of claim 8 wherein said active monomer comprises an organic polymer precursor.

13. The sensor of claim 8 wherein said plurality of organic polymer particles comprises a plurality of polystyrene spheres.

14. The sensor of claim 8 wherein said substrate comprises glass.

15. A method of configuring a macroporous sensor, said sensor comprising:
configuring a plurality of organic polymer particles on a substrate via a vertical deposition operation to form a target template having a plurality of pores;
adding an active monomer to a solution during an infiltration operation with respect to said target template, said active monomer is associated with a plurality of ligands and is polymerized about said target template; and
said target template is removable to form a macroporous electrode for use in sensing operations by said macroporous sensor.

16. The method of claim 15 further comprising:
stereochemically fixing said plurality of ligands at precise binding sites associated with said target template;
configuring said macroporous sensor with an inverse opal macroporous backbone structure; and
depositing a layer of said target template and said active monomer to form a plurality of molecular imprinted active sites on said inverse opal backbone structure after a self-assembly and polymerization process step.

17. The method of claim 15 wherein said active monomer comprises an organic polymer precursor.

18. The method of claim 15 wherein said plurality of organic polymer particles comprises a plurality of polystyrene spheres.

19. The method of claim 15 wherein said macroporous electrode comprises an ordered, three-dimensional structure.

20. The method of claim 15 wherein said substrate comprises glass.
